(19) United States
(12) Patent Application Publication
(10) Pub. No.: US 2003/0024822 A1
(43) Pub. Date: Feb. 6, 2003

(54) PROCESS FOR THE DEPOSITION OF A SILVER-TIN ALLOY

(76) Inventor: Ortrud Steinius, Wuppertal (DE)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/890,600

(22) PCT Filed: Mar. 22, 2001
(86) PCT No.: PCT/US01/08622

(30) Foreign Application Priority Data
Mar. 24, 2000 (DE) 10014852.2

(51) Int. Cl. B05B 1/00; C09D 5/00; C09D 5/10; C25D 3/60; C25D 3/56

(52) U.S. Cl. 205/254; 205/238; 205/253; 106/1.14; 106/1.19; 106/1.23

(57) ABSTRACT

The invention concerns a process for the deposition of a silver-tin alloy from an acidic, cyanide-free electrolyte, containing silver ions, tin ions as well as a complexing agent. In order to provide a process which, despite the great differential of potential between silver and tin, makes it possible to simultaneously precipitate both metals to form well-adhering layers which, in addition, have a smooth, matte to silky surface and which are easily soldered, the invention involves the use of, as a further component an aromatic compound with an aldehyde group added to the electrolyte.

The invention concerns a process for the deposition of a silver-tin alloy from an acidic, cyanide-free electrolyte containing silver ions, tin ions as well as a complexing agent.

Processes for the deposition of silver and also of silver alloys are known from the state of the art and are frequently used in practice, based on different electrolytes. The use of cyanide containing electrolytes is widespread. However, they have the disadvantage of being highly poisonous which makes their use problematic from the environmental point of view. Therefore, cyanide-free electrolytes have been developed which, for example, are based on thiosulfate to which silver has been added in the form of silver nitrate or silver chloride. An electrolyte based on silver nitrate for the deposition of a silver-tin alloy is published in EP 0 666 342 B1, for example. The use of silver complexes for deposition from silver electrolytes is also known. Thus, EP 0 829 557 A1 as well as EP 0 893 514 A2 each show electrolytes built on the basis of silver iodite and tin pyrophosphate.

However, compared to cyanide containing electrolytes, the above mentioned electrolyte types have the disadvantage of being very sensitive to contamination, or they permit only slow deposition rates. In addition, it may he necessary, in order to obtain good adherence, to build a preliminary coating again using a cyanide-containing electrolyte. The already discussed environmental problems are the result.

In order to avoid the above-mentioned disadvantages it is the purpose of the invention to present a process for the deposition of a silver-tin alloy which, despite the large potential differential between silver and tin, permits the simultaneous deposition of both metals from an acid solution to form well-adhering layers which show a matte to silky appearing, smooth surface and which can easily be soldered.

To achieve this purpose, the invention provides that, as a further component, an aromatic compound with an aldehyde group be added to the electrolyte.

With this process, in accordance with the invention, the formation of a silver-tin alloy layer by electrolytic deposition means is provided, whereby as a further component, an aromatic compound with an aldehyde group is added to the electrolyte. Thus, the deposition of a silver-tin alloy can be achieved in an environmentally safe manner. In addition, it is of advantage that, in accordance with the invention, the process for silver-tin deposition permits a wide current density range, so that also high current densities can be used for building a smooth, well-adhering coating. Thus, smooth, easy to solder silver-tin coatings can be achieved which satisfy good adhesion requirements without building up a preliminary coating.

This process, in accordance with the invention, permits building a silver-tin coating by means of electrolytic deposition, whereby, advantageously, environmentally unsafe cyanide containing electrolytes can be eliminated and electrolytes are used instead which, as additional component, contain a non-toxic aromatic compound with an aldehyde group. Such electrolytes, also in the strongly acidic range, retain both silver ions and tin ions in a stable solution, and they permit the formation of uniform, well-adhering layers.

In accordance with one aspect of the invention, an aromatic compound with an electron-attracting, acidic group is used. Especially suitable are COO⁻; SO₂O⁻; as well as NO⁻₂. Alternatively, an aromatic compound with a tautomerism-stabilizing group with N or O atoms can also be used. Especially suitable for this purpose is N(CH₃)₂.

In accordance with a further aspect of the invention, a substituted benzaldehyde can be used as the aromatic compound and added to the electrolyte as a the further compound.

In accordance with a further aspect of the invention, a benzol derivative is used as the aromatic compound.

The addition of further components to the electrolyte in accordance with the invention mentioned above as examples permits an advantageous compounding of an electrolyte which permits the deposition of well-adhering silver-tin layers, while maintaining both silver and tin ions stable in the solution without the addition of cyanide, despite the great difference in potential between silver and tin. The structural formulae of the above mentioned additional component examples are shown in the following:

a) Component 1: An aromatic with an aldehyde group and an electron-attracting, acidic group (where, for example, x═COO⁻, SO₂O⁻, NO⁻₂)

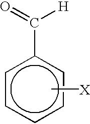

b) Component 2: An aromatic with an aldehyde group and a tautomerism-stabilizing group, containing N or O atoms (where, for example, x═N(CH₃)₂).

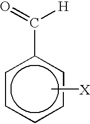

c) Component 3: A substituted benzaldehyde

In accordance with a further aspect of the invention, thiourea and/or its derivatives are used as a complexing agent As a complexing agent, the thiourea permits weakening of the bond of the positively-charged silver ions. A silver-thiourea complex forms and the potential of the silver is diminished due to the complexing. In addition to thiourea, iodite, sulfite, thiocyanate, ethylenediamine or similar compounds also are suitable complexing agents.

In accordance with the invention, a tin (II) or a tin (IV) compound is used as tin ion source. Here, tin-methanesulfonate is especially suitable since it is easily obtained, and it is quite compatible with regard to mixing different methanesulfonates. Also, in accordance with the invention, silver salts of organic acids are used as the source of silver ions. For example, propionic acid, acetic acid, methanesulfonic acid, pyrophosphoric acid or sulpharnic acid may be used for this purpose. Methanesulfonic acid has proven to be especially suitable since the use of silver and tin-methanesulfonate in a methanesulfonate based electrolyte permits the application of high current densities. In this manner, coatings are achieved which are easily soldered and have smooth surfaces.

To carry out the process suggested by the invention, a cyanide-free electrolyte is suggested for the galvanic precipitation of silver-tin alloys which contains silver ions, tin ions and a complexing agent and which is characterized by an aromatic compound in connection with an aldehyde group as an additional component. The electrolyte may contain the above-mentioned components in the preferred manner as follows:

1. Tin ions (Sn²⁺:

A bivalent tin salt is preferred as the tin source, e.g., tin methanesulfonate, in an amount of 1 to 30 g/l in the electrolyte.

2. Silver ions (Ag⁺):

Preferred as a silver ion source is a silver salt, e.g., silver methanesulfonate, in the amount of 0.1 to 10 g/l in the electrolyte.

3. An acid:

Preferred is methanesulfonate acid in the amount of 5 to 200 g/l in the electrolyte, whereby the pH of the electrolyte is preferably above 1.

4. A complexing agent:

Preferred is thiourea and/or its derivatives in a quantity of 5 to 50 g/l.

5. As a further component an aromatic compound with an aldehyde group, e.g., nitrobenzaldehyde, phthalic acid aldehyde, dimethylaminobenzaldehyde, preferably benzaldehyde-sulphonic acid-sodium salt in a quantity of 0.5 to 10 g/l.

It has been noted that silver ions remain in stable solution in the electrolyte. Preferably, the electrolyte is run at a current density of 0.3 to 5.0 A/dm² and at room temperature. In addition, known measures from the current state of the art can be used in applying the process which is the subject of the invention. This includes, e.g., running the electrolyte above room temperature, was well as the use of an additional brightener.

Additional details, characteristics and advantages of the invention are shown in the following examples each of which describes an electrolyte composition.

Comparative composition

| | | |
|---|---|---|
| Tin ions (Sn²⁺) | 17 | g/l |
| Silver ions (Ag⁺) | 0.5 to 3 | g/l |
| Methanesulfonic acid | 160 | g/l |
| Thiourea | 10 | g/l |

An electrolyte composition of this type is unstable. The silver drops out of solution. The deposition of a silver-tin alloy is not possible, based on such an electrolyte.

According to the invention, an aromatic compound with an aldehyde group is added to the electrolyte. For example, the following electrolyte compositions are prepared:

| Example | | 1 | 2 | 3 | 4 | 5 | 6 | 7 | 8 |
|---|---|---|---|---|---|---|---|---|---|
| Tin ions (Sn²⁺) | g/l | 17 | 19 | 10 | 10 | 17 | 17 | 20 | 17 |
| Silver ions (Ag⁺) | g/l | 3 | 0.5 | 0.1 | .02 | 0.2 | 2 | 0.5 | 3 |
| Methanesulfonic | g/l | 160 | 160 | 180 | 160 | 170 | 190 | 200 | 190 |
| acid | | | | | | | | | |
| Thiourea | g/l | 10 | 10 | 10 | 10 | 10 | 10 | 10 | 10 |
| Benzaldehyde- | g/l | 2.5 | 2.5 | 2.5 | 2.5 | — | — | — | — |
| sulfonic acid | | | | | | | | | |
| Benzamide | g/l | | | | | 2.5 | — | — | — |
| Nitrobenzaldehyde | g/l | | | | | | 2.5 | | — |
| Dimethylaminoben- | g/l | | | | | | | 2.5 | — |
| zaldehyde | | | | | | | | | |
| Phthalicacid- | g/l | | | | | | | | 2.5 |
| aldehyde | | | | | | | | | |

The silver remains stable in the electrolyte solution. The deposition of a silver-tin alloy takes place between 0.1 and 5 A/dm². The silver content is between 0.5 and 25%, depending on the electrolyte.

In addition to the use of methanesulfonate acidic solution, silver and tin ions may also be kept in a stable solution with the following compounds: 2-nitrobenzaldehyde, phthalicacidaldehyde as well as 4-dimethylaminobenzaldehyde. However, it turns out that the electrolytic deposition of both silver and tin from these solutions is amorphous.

Carrying out the process as described in the invention permits the deposition of a silver-tin alloy from a cyanide-free complexing agent, whereby despite the large potential difference between tin and silver, the building of smooth-surfaced and well-adhering layers is possible. The deposited layers are matte to silky in appearance, depending on the additives. The suggested process is environmentally benign in an advantageous manner.

1. A process for the deposition of a silver-tin alloy from an acidic, cyanide-free electrolyte, containing silver ions and tin ions as well as a complexing agent characterized by the electrolyte having added to it an aromatic compound with an aldehyde group as a further component.

2. A process in accordance with claim 1, characterized by an aromatic compound with an electron-attracting, acidic group being used.

3. A process in accordance with claim 2, characterized by an electron-attracting, acidic group: COO⁻, SO₂O⁻ or NO⁻₂ being used.

4. A process in accordance with claim 1, characterized by an aromatic compound with a tautomerism-stabilizing group, containing N or O atoms being used.

5. A process in accordance with claim 4, characterized by a tautomerism-stabilizing group N(CH₃)₂) being used.

6. A process in accordance with claim 1, characterized by a substituted benzaldehyde being used as a substituent for an additional component.

7. A process in accordance with claims 1 to 6, characterized by a benzol derivatives being used as aromatic compound.

8. A process in accordance with one of the foregoing claims, characterized by a tin(II) or a tin(IV) compound being used as the tin ion source.

9. A process in accordance with one of the foregoing claims, characterized by silver salts of organic acids being used as the silver ion source.

10. A process in accordance with one of the foregoing claims, characterized by propionic acid, acetic acid, methanesulfonic acid, pyrophosphoric acid, sulpharnic acid or similar material being used as acid.

11. A process in accordance with one of the foregoing claims, characterized by thiourea and/or its derivatives are used as a complexing agent.

12. A process in accordance with one of the foregoing claims, characterized by iodite, sulfite, thiocyanate, ethylenediamine or similar material being used as complexing agent.

13. Cyanide-free electrolyte for the galvanic precipitation of silver-tin alloys, containing silver ions, tin ions as well as a complexing agent characterized by an aromatic compound with an aldehyde group being used as an additional component.
